(19) United States
(12) Patent Application Publication
(10) Pub. No.: US 2008/0294522 A1
(43) Pub. Date: Nov. 27, 2008

(54) Method of automated distribution of advertising messages and system for carrying out the method

(75) Inventor: Oleg O. Teterin, Moscow (RU)

Correspondence Address: HOUSTON ELISEEVA, 4 MILITIA DRIVE, SUITE 4, LEXINGTON, MA, 02421, US

(73) Assignee: "SUPERFONE" LLC, Moscow (RU)

(21) Appl. No.: 11/971,853

(22) Filed: Jan. 9, 2008

(30) Foreign Application Priority Data
Jan. 10, 2007 (EA) 200700300

(51) Int. Cl. G06Q 30/00

(52) U.S. Cl. 705/14

(57) ABSTRACT

The method of advertisements automated distribution includes generating the advertising information with indication of display parameters, providing the advertisements, receiving by the user mobile device at least advertisements as provided by the advertisements generation unit, storing at least the received advertising information, sending and providing the advertising information as chosen from the stored advertising information to the addressee mobile device when sending the connection request with the addressee mobile device differs that the mobile communication devices users are registered, advertisements are generated with classification features of mobile communication devices users, the above message is sent to the distribution process control computer, advertisements block which includes at least one advertisement is generated responding to the above received message to send to the particular user, requests with regard to the classification features of this user are generated to allow receiving the above advertisement blocks by users and if acknowledged the above advertisement blocks are sent to users mobile communication devices. The proposed advertisements automated distribution system includes the advertisements generation unit, mobile communication device which includes at least the sender and receiver which serves to receive at least the advertising information, memory unit which serves to store at least advertising information and to record and store the displayed advertisements information; interface unit which serves to send and provide the advertising information stored in the memory unit to the addressee mobile communication device when sending the connection request from the mobile communication device to the addressee mobile device, mobile communication service provider network which includes at least one computer which provides the advertisements distribution process control and the unit which serves to store the information. The advertisements generation unit is linked to the storage device which is linked to the computer providing the advertisements distribution and presentation process control linked to the communication service provider network.

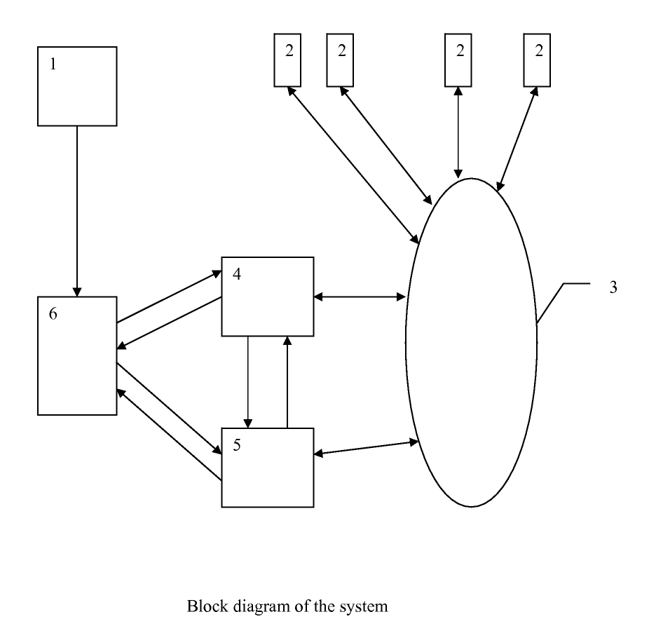

### RELATED APPLICATIONS

This application claims priority to Eurasian Patent Application No. 200700300, filed on Jan. 10, 2007, which is incorporated herein by reference in its entirety.

### BACKGROUND OF THE INVENTION

The invention relates to the advertising business and namely to the methods of advertisements automated distribution through the telecommunication channels and their implementation systems and may be used to promptly provide the mobile communication users with products and services advertising information.

Recently, the number of mobile communication users is being increased continuously. The technological development in the sphere of telecommunications and microelectronics resulted that the colour displays mobile phones with quite powerful microchips and memory devices that allow to store and process the large data volumes (for example, Smartphone type mobile phones) are available to a large number of people. Today using the mobile communications not only the text information but also the complex graphical images supported by the audio information may be sent and subsequently viewed on the mobile phone display. Thus, not only the text information but also the audio-visual advertisements sent by the advertiser through the telecommunication channels to the users may be viewed on the mobile phone display.

Under severe competition conditions and goods and services flow the advertisement becomes more important. Those goods and services will be successfully sold which properties and availability are known by the user. Therefore, the goods and services suppliers take their pains to provide the potential purchasers with information on their goods and services as much as possible taking advantage of any capabilities including those as new information processing technologies (Internet network, mobile communications).

Thus, today the Internet advertisement become widely used in the Internet network. It is generally presented either as banners that provide the advertiser messages or distributed as the electronic letters. However, the more advertisement appears as banners and electronic letters the less effective becomes the advertisement. This happens due to the fact that these types of advertisement have some disadvantages. On the one hand the banners are available at all times and without regard to the user's interests, they are too much like each other and hence not of interest to the user, therefore, the user may just easy ignore them. On the other hand the user may just scroll the banner images on the display until they are completely disappeared. The banners take also significant area on the display, block and overfill the display causing the trouble to the user and this may result in making the negative impression of the advertiser. The electronic letters with advertisements just often fail to reach the addressee as they are automatically distributed to spams by mailing systems and can not be come to the user's mailbox.

Goods and/or services advertising by the occasional and obtrusive animated multimedia sign displayed at the PC screen (this advertising method is described in the RF patent No. 2259585 IPC 7 G06F17/60) is also definitely not free of the above disadvantages. In the method that has previously been proposed the multimedia sign displays at the monitor screen unexpected and quite uncontrolled to the user without agreement and regard to his/her interests which can trouble the user and finally the advertisement will be less effective.

It has previously been proposed to distribute advertisements in the telecommunications network by their linking to the electronic messages (U.S. Pat. No. 6,622,124 IPC G06Q 30/00). In this method the advertisement to be sent to the user is chosen with regard to his/her features (age, sex) stored in the server connected to the communications network. However, this method does not take the user's agreement for distribution of advertisements to his/her address into account making the advertisements less effective.

Recently, the advertisers more and more active take advantages of using the mobile communications for advertisements distribution purpose. It has previously been proposed to send the advertisements through the short message service (SMS) (European patent claim EP0986273 IPC H04M3/487). This method, however, does not also take the user's agreement for distribution of advertisements and his/her preferences to view the advertisements into account that result that the mobile phone user will just refuse to view the advertisements received as SMS messages. Therefore, the effectiveness of advertisement to be distributed by this method will be low as the advertisement will reach only some mobile phone users.

The effectiveness of advertisement to be distributed by the telecommunications network may be improved by the distribution of personalized advertisements provided that the addressee will be interested in viewing the coming advertisements.

The equivalent of the claimed invention is the method to distribute personalized advertisement and information messages to the users as described in the U.S. Pat. No. 5,933,811, IPC G06Q 30/00 and based that the central station records the advertisement and information messages suppliers and users and generates their accounts. Each advertisements and information message that is sent to the user terminal by the suppliers after receiving the corresponding request together with the image of the message supplier page is paid by remittance in cash or non-cash received from the suppliers. The system that realizes the previously proposed method records the number of messages received by the users following the remittance to the account of each registered user for these delivered advertisement and information messages.

Broadly, the common features with the claimed method are as follows:
recording the advertisement and information messages suppliers;
recording the advertisement and information messages addressees;
generating the accounts for both advertisement and information messages suppliers and addressees;
sending the advertisement and information messages to the user terminal;
remitting money to the account of each registered user for delivered advertisement and information messages.

The disadvantages of this method should relate that the users have to perform additional actions after registration at the content provider terminal and namely to call for resources of advertisement and information messages suppliers. Thus, the user shall be informed about who is the supplier of this content provider and about the supplier resources address. In this case the users have to initiate themselves the messages distribution every time that prevents to distribute within the wide range and to achieve the maximum coverage for the target audience while the advertisement and information messages suppliers may indirectly influence the qualitative and quantitative characteristics of the target audience.

It has also previously been proposed to distribute the personalized advertisement and information messages (RF patent No. 2192049, IPC G09F 19/00) based that the advertisement and information messages suppliers are registered by recording the numbers assigned to them and their names in the central station database, the advertisement and information messages users and their user terminal registration numbers are recorded at the central station and the users classification features are entered in the database, the money received from the supplier is remitted to the account generated in the payment system of the central station for each advertisement and information messages supplier in cash and/or non-cash, advertisement and information messages meant for sending to the users are generated where each message contains the address which includes the message identification number and the user terminal registration number and the content of the advertisement and information message and send them to the chosen user addresses as specified. If the user terminal receives the message the feedback signal containing the user terminal registration number and indication of time of this message receipt and its identification number initiated by the user or automatically from this user terminal is sent to the central station, if the feedback signals have been received the central station fixes the acknowledgement of the messages received by the users and missing the feedback signals is taken to be inaccessible for this user terminal that is also recorded and the number of advertisement and information messages received by each user is counted following the remittance to the account of each registered user as generated in the payment system of the central station for delivered advertisement and information messages. Also the central station award the bonus discount to the user for receiving of each advertisement and information message. The central station database is generated that includes identification numbers of advertisement and information messages, their content meant for sending to the users as well as their distribution conditions agreed with suppliers, generate the accounts of the advertisement and information message suppliers in the payment system of the central station, single user information that includes registration number for each user, user terminal registration number, personal information and information corresponding to the above classification features. Based on the compared information which contains in the central station database corresponding to the above specified classification features the information coincided on the whole or partially with the features is entered to the database on which basis the distribution lists are generated, where each of them includes the user registration number, user terminal registration number, personal user information and/or advertisement and information messages requested by each user, and/or advertisement and information messages with their identification numbers related to the single supplier, and/or distribution conditions for advertisement and information messages. The information on compliance of the number of received advertisement and information messages, performed bonus discounts units charges for receiving the messages and remittances to the users accounts is entered in the database, the information on charges and compliance of the sent messages and performed remittances to the users accounts for receiving the corresponding messages are generated for each advertisement and information messages supplier. At the central station the specified sum received from the advertisement and information messages suppliers registered in the payment system is remitted for services supplied and all expended money remitted to the central station payment system is counted for each advertisement and information messages supplier, calculate the remaining balance on each supplier account and send this information to the relevant supplier following the repayment of the above remaining balance to suppliers or change the second area information in respect to each supplier, then define the difference between the money received from the supplier for delivered advertisement and information messages and charged bonus discounts to user for relevant messages received which is remitted to the central station account and generate the database area that includes the information on charged bonus accounts of the central station according to the number of the messages sent from the advertisement and information messages supplier to the users, then, if necessary, as requested by the registered users by searching the user registration number at the central station database the charged bonus account and messages sent by this user on done charges are checked and as requested by the registered users their individual information is fully or partially changed or deleted in the database, at this as requested by the advertisement and information messages suppliers the original advertisement and information messages and distribution conditions sent to these suppliers are fully or partially changed or deleted in the central station database. This method may be considered to be the equivalent to the claimed invention.

The system that realizes the described method is a software and hardware interface which includes databases linked with the processor, request search unit, request generation unit and reproducing unit linked via the information and control buses to the processor and databases.

The described method and the system, however, are not capable to send several advertisements to user devices at the same time which necessitate to provide link between the user device and the central station to send each advertisement, in this case the user has to carry out additional actions on his/her device to view the received advertisement making the advertisements less effective.

Some features of the claimed invention coincide with the that of the above method. These are:
recording the advertisement and information messages suppliers in the database;
recording the users in the database;
generating the advertisement and information messages;
generating the advertisement distribution lists with regard to users classification features;
distributing the advertisements to user;
charging the units to user account;
changing the advertisement supplier account;
recording the acknowledgements for messages received by users at the central station;
providing access to the user for his/her account viewing;
providing access to the central station database to change users and advertisement suppliers information.

The most similar equivalent of the claimed method is the previously proposed method of mobile communications advertising as described in the US patent claim No. 20050227679, IPC H04Q 007/20 which includes as follows: generating the advertisement request in the original mobile communication device; sending the advertising information request to the advertisements generation unit; providing the advertising information as requested by the advertisements generation unit; receiving at least the requested advertising information provided by the advertisements generation unit; storing at least the requested the advertising information; sending and presentation of the advertising information as chosen from the stored requested advertising information to the addressee mobile device when sending the connection request with the addressee mobile device; and recording the chosen advertising information provided to the user.

The disadvantages of the proposed method may firstly include that the large volume of traffic is required to exchange the information between the advertisements generation unit and the users mobile devices which necessitate every time to send the relevant request to the advertisements generation unit in order to receive the advertisements and secondly the missing user possibility to influence the advertisement provision duration on the mobile phone display making the advertisement less effective as the user in hurry to response the call is not always able to view and keep the displayed advertisement in his/her mind. Also the method does not provide the user the possibility to influence the choosing the advertising subject making again the advertisement less effective.

Some significant features of the claimed invention coincide with the significant features of the above method. These are:
generating the advertising information;
providing the advertising information;
receiving at least the advertising information provided by the advertisements generation unit;
storing at least the advertising information;
sending and presentation if the advertising information as chosen from the stored requested advertising information to the addressee mobile device when sending the connection request with the addressee mobile device.

The previously proposed system of mobile communications advertising as described in the in the US patent claim No. 20050227679, IPC H04Q 007/20 may be dealt with as the most similar equivalent of the claimed system. This system includes as follows: advertisements generation unit which serves to store the advertising information files and provide the advertising information requested; original mobile communication device; and the service provider network which serves to provide communication between the advertisements generation unit and original mobile communication device where the mobile communication device in turn includes as follows: requests generation unit which serves to generate the advertising information requests; sender which serves to send at least the advertising information request to the advertisements generation unit; receiver which serves to receive at least the requested advertising information provided by the advertisements generation unit; memory unit which serves to store at least the requested advertising information; interface unit which serves to send and provide the advertising information as chosen from the requested advertising information and stored in the memory unit to the addressee mobile device when sending the connection request from the original mobile communication device to the addressee mobile device; and the report unit which serves to record the advertising information provided to the interface unit user.

Some features of the claimed system coincide with that of the above system. Namely, the claimed system like the system previously proposed includes as follows:
advertisements generation unit;
mobile communication device which includes the sender; receiver which serves to receive at least the advertising information provided by the advertisements generation unit; memory unit which serves to store at least the advertising information; interface unit which serves to send and provide the advertising information as chosen from the advertising information and stored in the memory unit to the addressee mobile device when sending the connection request from the original mobile communication device to the addressee mobile device;
service provider network.

The disadvantages of the above system may relate to missing the user possibility to influence the choosing the advertising subject making the advertisement less effective. This disadvantage is due to the system design features, i.e. missing system store and processing unit for classification features of advertisement users.

### SUMMARY OF THE INVENTION

The object to be solved by the claimed invention is to provide the high-efficiency automated method to distribute the personalized advertisements that the mobile phone user is interested to receive and to provide the reliable system for its implementation.

The technical outcome to be achieved by using the proposed invention is firstly to decrease the volume of traffic necessary to implement the method resulting in decreasing the cost for method implementation and secondly to improve the effectiveness of the method and the reliability and to extend the system capabilities intended to implement the claimed method.

The above object is solved and the technical outcome is achieved in the method of advertisements distribution thanks to as follows: generating the advertising information, providing the advertising information, receiving at least the advertising information by the mobile communication device provided by the advertisements generation unit, storing at least the received advertising information, sending and presentation of the advertising information as chosen from the stored and received advertising information to the addressee mobile device when sending the connection request with the addressee mobile device, recording the mobile communication device users, generation of advertisements packages that include at least the single advertisement with regard to the classification features of mobile communication subscribers, generating the requests to possible receiving the above advertisements packages and sending the above advertisements packages to users mobile communication devices by acknowledgement of the possible receiving the above advertisements packages.

In order to achieve the object of the invention the following measures are also taken:
So as the mobile phone user could closely view the advertisement image at the phone display the image indicates on the phone display until either the disconnection button is pressed or this button is repressed or until the cancel connection button is pressed by this user.
The acknowledgement of advertisements package received by the mobile communication device is recorded. For this, responding to the received advertisements package the user mobile communication device automatically sends a signal which acknowledges the relevant advertisement received following charging the units to the user account. The user is provided the access to the balance information.
The memory of the mobile communication device records the acknowledged displayed advertisements.
Requests to possible receive the advertisements packages by users are sent with regard to the mobile network loading.
The message with the classification features of the user mobile communication device is generated by responding the certain questions which are sent as questionary to the user mobile communication device.
The database which includes information on users (mobile communication subscribers), service providers and advertisements distribution conditions is generated.
The user information is entered in the database if the message with his/her classification features is received.
The advertisements are provided with classification features.
The advertisement includes textual and/or graphical and/or audio and/or video information.
The advertising information as chosen from the stored advertising information to the addressee mobile device is sent and presented when sending the message to the mobile communication device.

The above object is solved and the above technical outcome is also achieved in the advertisement automated distribution system thanks to as follows: advertisements generation unit, mobile communication device which includes the sender, receiver which serves to receive at least the advertisements, memory unit which serves to store at least the advertising information; interface unit which serves to send and provide the advertising information stored in the memory unit to the addressee mobile communication device when sending the connection request from the mobile communication device to the addressee mobile device, mobile communication service provider network, additionally the system includes at least one computer which provides the advertisements distribution process control, and the unit which serves to store the information and the mobile communication device which additionally includes the unit which serves to control the sending and presentation of the advertising information stored in the memory unit to the addressee mobile communication device when sending the connection requests with the addressee mobile communication device and the above memory unit which also serves to record and store the displayed advertisements information. The advertisements generation unit is linked to the storage device which is linked to the computer providing the advertisements distribution and presentation process control linked to the communication provider network.

Additionally, for the purpose to achieve the object of the invention the computer providing the advertisements distribution and presentation process control includes the unit which serves to count the advertisements sent to the particular users and their displayed number and the amount of award for received advertisements. The storage device may be represented as the data storage. The device which serves to control the sending and presentation of the advertisements may also generate the messages. To improve the reliability the system may include two or more parallel linked devices that provide the advertisements distribution process control in synchronized manner.

The storage device includes at least the database which contains the mobile phones users, advertisement suppliers and viewed advertisements information.

The possibility to distribute the personalized advertisements (with regard to user features) only to those mobile communication users who have agreed to receive them which is provided thanks to the user registration in the system by responding the answers to the questionary questions with their following dully processing, extending the system capabilities and allow to significantly improve the advertising effectiveness as the user received the advertisement would certainly view it and the received advertisement would not trouble him/her but would more likely of interest to him/her. The possibility to get the financial award for agreement to distribute the advertisements which is provided by the registration in the computer providing the advertisements distribution process control, unit which serves to count the advertisements sent to the particular users and the amount of award for received advertisements also promote to increase the user interest to advertisement and to improve the advertising effectiveness accordingly.

The advertisements distribution procedure provided in the method to be operated in response to the signal received in the advertisements distribution control computer meaning that the mobile device is ready to receive this message allows to prevent the request to receive the advertisements and the ineffective advertisements distribution resulted in decreasing the volume of traffic necessary to implement the claimed invention and to decrease the method cost accordingly.

The incorporation of the some parallel synchronized advertisements distribution control computers to the system improves the system and method reliability as it provides continuous operation of the system in case of failure of one of the computers.

### BRIEF DESCRIPTION OF THE DRAWINGS

The claimed invention is illustrated in the FIGURE which shows the system flowchart.

### DETAILED DESCRIPTION OF THE PREFERRED EMBODIMENTS

The system includes the advertisements generation unit 1, several mobile communication devices 2, mobile communication service provider network 3, computers that provide advertisements distribution control process, 4 and 5 and storage device 6.

The advertisements generation unit 1 is linked through the communication channels to the storage device 6 linked to computers providing the advertisements distribution control process, 4 and 5 accordingly where each of them is linked through the communication channels to the mobile communication service provider network 3. The computers 4 and 5 are interlinked through the communication channel (for example, through the channel supporting the Ethernet protocol) which allows to synchronize their operation. The mobile communication devices 2 are linked to the mobile communication service provider network 3.

The advertisements generation unit 1 is the computer which functions as follows:
receives the advertisements sent from the advertisement suppliers;
stores the received advertisements;
classifies the advertisements according to their classification features;
combines the advertisements with the same classification features to advertisement blocks;
sends the advertisement blocks to computers 4 and 5.

The advertisements generation unit 1 is capable to receive the advertisements from the advertisement suppliers both through the Internet network and through entering the information from any media (CD, DVD etc.)

The advertisements generation unit 1 may be realized on the computer basis, for example with the following configuration parameters: processor (CPU) not less than 3.4 GHz, cache not less than 2×2 MB (for example, Intel Pentium D 945 3.4 GHz Dual core), memory (RAM) 4 Gb, disc space not less than 160 Gb with use of NetBSD operating system.

The mobile communication device 2 is the mobile phone which is provided at least with the sender, receiver that provides the receiving at least the advertisements to be provided by the computers 4 and 5; memory unit which serves to store at least the advertising and displayed advertisement information; interface unit which serves to send and provide the advertising information stored in the advertisement memory unit, i.e. unit which serves to control the sending and presentation of the advertisements stored in the advertisement memory unit and to generate messages to be sent to computers 4 and 5. The following types of mobile phones may be used as the mobile communication device 2: Smartphone type phones with Symbian, Windows Mobile, Palm, Linux or RIM operating systems. These phones include the sender, receiver, memory unit which serves to store the information, interface unit which provides the information sending and presentation on the phone display, microprocessor on which bases the device providing per set algorithm the control for sending and presentation of advertisements stored in the memory unit and generation of messages to be sent to computers 4 and 5 may be realized.

The algorithm to which the sending and presentation of the advertising information appear on the user phone display is set by the advertisement supplier who indicates how many times and when shall the advertisement be presented to the user of the mobile communication device 2. The algorithm to which the messages are generated to be sent to computers 4 and 5 is set by the computer 4 and 5 and defined by the traffic loading level and advertisement supplier requirements. The above algorithms may be represented as programmes built in the standard programming language, for example Perl or C.

The mobile communication service provider network 3 is a complex of devices that provide the interaction between the mobile communication operator and the user.

The computer (4, 5) which provides the advertisements distribution process control functions at least as follows:
generates the messages to be sent to the mobile communication devices 2 which include personalized advertisement blocks;
sends the messages to mobile communication devices 2 according to the set distribution procedure;
searches the messages to mobile communication devices 2 in information reception standby;
receives the messages sent from the mobile communication devices 2;
classifies the messages sent from the mobile communication devices 2 according to their content;
sends the messages to the storage device 6;
receives the messages sent from the storage device 6;
receives the messages sent from the advertisements generation unit 1

The computers 4 and 5 which provide the advertisements distribution process control are synchronized and therefore operate in the same mode and can not be considered as single unit.

These units 4 and 5 may be realized on the computer base, for example with the following configuration parameters: processor (CPU) not less than 3.4 GHz, cache not less than 2×2 MB (for example, Intel Pentium D 945 3.4 GHz Dual core), memory (RAM) 4 Gb, disc space not less than 160 Gb with use of NetBSD operating system.

The storage device (data storage) 6 which serves to collect, control and store the information performs integration, conversion, consolidation, cleaning and immediate storage of the information as well as provides the information for assessment and interpretation.

The storage device 6 serves to collect, control and store the information necessary at least to generate the personalized advertisement blocks, to generate the service providers and mobile communication users accounts agreed for advertisements distribution and to generate the history reports.

The storage device 6 includes at least the following databases:
database for users with personal features registered in the system;
database for advertisements with indication of advertisements classification features
database for users accounts;
database with displayed advertisements history information

The storage device 6 may be realized on the computer system base from the known world manufacturers (for example, on the ASUS R120-E3(PA4) server-based platform): processor (CPU) not less than 3.4 GHz, cache not less than 2×2 MB (for example, Intel Pentium D 945 3.4 GHz Dual core), memory (RAM) 4 Gb, disc space not less than 160 Gb with use of NetBSD operating system.

In case of implementation of the claimed method the claimed system operates as follows.

The user of the mobile communication device 2 who desires to receive the advertisements for remuneration generates the short message (SMS) on his/her mobile communication device 2 which is to be sent to the advertisements distribution process control computer 4, 5 by the set number through the mobile communication service provider network 3. This computer 4, 5 identifies the received message as the request for system registration and responds the message through the mobile communication service provider network 3 to the user address who has sent the message containing questions, for example, regarding his/her personal features (sex, age, family status, finance position etc.) where answers allow to send to this user only those advertisements which would be of interest to him/her. The user having received the above message generates using his/her mobile communication device 2 answers to questions raised in questionary and sends them as message through the mobile communication service provider network 3 to advertisements distribution process control computer 4, 5 where this message is identified as answers to questionary questions and sent through the storage device 6 to the relevant database. In this case in the advertisements distribution process control computer 4, 5 and the above database record that this user has been registered in the system meaning that this users agrees to receive the advertisements. The acknowledged user registration in the advertisements distribution process control computer 4, 5 is recorded as an event after which the specified computer 4, 5 sends a program to the mobile communication device 2 which realizes the advertisements presentation algorithms and displayed advertisements counting as set by advertisement suppliers as well generation of service messages to be sent to the advertisements distribution process control computer 4, 5.

The advertisements provided with classification features (for example, only for women, unmarried users, users with particular phone model etc.) are sent to the storage device 6 from the advertisements generation unit 1. In the storage device 6 the classification features of these messages are compared with the users classification features and following the comparison results (features shall be the same) the advertisement blocks are generated personally for each user and following the request sent from the advertisements distribution process control computer 4, 5 the messages are sent to the specified computer 4, 5.

The advertisements distribution process control computer 4, 5 counts the sent advertisements and the number of each displayed advertisements and if the advertisement presentation conditions (number of presentations, presentation time etc.) as set by the advertisement supplier are fulfilled the request as sent to the storage device 6 is generated to provide the advertisement block for the particular user (sends the user phone number as his/her identification parameter, for example). The storage device 6 identifies the signal received from the advertisements distribution process control computer 4, 5 as a request to receive the advertisement block and sends the advertisement block associated with the particular user back to the advertisements distribution process control computer 4, 5. The advertisements distribution process control computer 4, 5 defines the status of the mobile communication device 2 of the particular user and sends the specified message containing the advertisement block through the mobile communication service provider network 3 if this mobile communication device 2 is in standby mode. The mobile communication device 2 receives this message, records in the storage device, fixes the acknowledged received message and parameters that describe the advertisements presentation conditions in the device which provides control for advertisements sending and presentation. If the mobile communication device 2 receives either the connection request with other mobile device or if it receives the message (SMS, MMS) the advertisement control and presentation unit selects the advertisement to be presented to the user according to the presentation conditions and sends the corresponding command to the interface unit which displays the specified advertisement on the mobile communication device 2. After hearing the call of the mobile communication device 2 the user usually takes the phone and may view the advertisement before the conversation. The advertisement may display on the mobile communication device 2 until disconnection or after disconnection until the certain button is pressed (for example, disconnection button).

The advertisements distribution process control computers 4, 5 fix the acknowledged start of connection with the calling user, account it as a certain event and record in the storage device 6. Within the time set by the advertisements distribution process control computers 4, 5 (for example, with regard to traffic loading) the advertisements distribution process control computers generate the message which includes instructions as to number for display of the relevant advertisements and send the message to advertisements distribution process control computers 4, 5. In the latter this message is identified as display number information and processed and recorded in the storage device 6.

According to the results of counted number of advertisements received by the mobile communication device and display number of these messages the advertisements distribution process control computer 4, 5 generates the information on which basis the money is remitted to the mobile user account, for example, from the advertisement supplier account.

The above proposal provides the better option to implement the claimed method and system but not the only possible.

In the previous implementation of the invention the device which provides the advertisements distribution process control, advertisements generation unit and storage device may be integrated as a whole.

While this invention has been particularly shown and described with references to preferred embodiments thereof, it will be understood by those skilled in the art that various changes in form and details may be made therein without departing from the scope of the invention encompassed by the appended claims.

What is claimed is:

1. The method of advertisements automated distribution which includes generating the advertising information with indication of display parameters, providing the advertisements, receiving by the user mobile device at least advertisements as provided by the advertisements generation unit, storing at least the received advertising information, sending and providing the advertising information as chosen from the stored advertising information to the addressee mobile device when sending the connection request with the addressee mobile device differs that the mobile communication devices users are registered, advertisements are generated with classification features of mobile communication devices users, the above message is sent to the distribution process control computer, advertisements block which includes at least one advertisement is generated responding to the above received message to send to the particular user, requests with regard to the classification features of this user are generated to allow receiving the above advertisement blocks by users and if acknowledged the above advertisement blocks are sent to users mobile communication devices.

2. The method as per claim 1 differs that the users mobile communication devices are registered after receiving the message of the user mobile communication device in the advertisements distribution process control computer which includes answers to the questions sent as a message to the user mobile communication device from the advertisements distribution process control computer responding to the message which includes the specified characters sent by the user to the advertisements distribution process control computer,

3. The method as per claim 1 differs that the advertisement image indicates on the mobile phone display once the connection button is pressed and until the disconnection button is pressed by the user.

4. The method as per claim 3 differs that the advertisement image indicates on the mobile phone display until the disconnection button is repressed by the user.

5. The method as per claim 1 differs that the advertisement image indicates on the mobile phone display until the cancel connection button is pressed by the user.

6. The method as per claim 1 differs that the acknowledged advertisements blocks received by the mobile communication device are recorded.

7. The method as per claim 1 differs that the acknowledged advertisements displayed on the mobile communication device are recorded.

8. The method as per claim 1 differs that the requests to allow receiving the advertisements blocks by the mobile communication device are sent with regard to mobile network loading.

9. The method as per claim 1 differs that the money is remitted to the user account depending on the number of advertisements sent to the mobile communication device.

10. The method as per claim 1 differs that the mobile communication device user is provided with access to his/her balance.

11. The method as per claim 1 differs that the database is generated which includes information on the mobile communication device users, service providers, advertisements distribution conditions.

12. The method as per claim 1 differs that the message with the classification features of the mobile communication device user is generated by answering the questions.

13. The method as per claim 1 differs that the information on the mobile communication device user is recorded in the database if the message with the user classification features is received.

14. The method as per claim 1 differs that the advertisements are provided with the classification features.

15. The method as per claim 1 differs that the advertisement includes the textual and/or graphical and/or audio and/or video information.

16. The method as per claim 1 differs that the advertising information as chosen from the stored advertising information is sent and provided to the addressee mobile device if the message is received by the mobile communication device.

17. The advertisements automated distribution system which includes the advertisements generation unit, mobile communication device which includes at least the sender and receiver which serves to receive at least the advertising information, memory unit which serves to store at least advertising information; interface unit which serves to send and provide the advertising information stored in the memory unit to the addressee mobile communication device when sending the connection request from the mobile communication device to the addressee mobile device, mobile communication service provider network which differs that the system additionally includes at least one computer which provides the advertisements distribution process control, and the unit which serves to the store information and the mobile communication device additionally includes the unit which serves to control the sending and presentation of the advertising information stored in the memory unit to the addressee mobile communication device when sending the connection requests with the addressee mobile communication device and the above memory unit which also serves to record and store the displayed advertisements information. The advertisements generation unit is linked to the storage device which is linked to the computer providing the advertisements distribution and presentation process control linked to the mobile communication service provider.

18. The system as per claim 17 differs that the computer which provides the advertisements distribution process control includes the unit which serves to count the advertisements sent to the particular users and to count the display number and the amount of award for received advertisements.

19. The system as per claim 17 differs that the storage device functions as the data storage.

20. The system as per claim 17 differs that it includes two or more parallel linked devices that provide the advertisements distribution process control in synchronized manner.

21. The system as per claim 17 differs that the storage device includes at least the database which contains information on mobile communication device users, advertisement suppliers, viewed advertisements, users and advertisement suppliers accounts.
